(19) United States
(12) Patent Application Publication
(10) Pub. No.: US 2008/0061237 A1
(43) Pub. Date: Mar. 13, 2008

(54) Microstructured Infrared Sensor

(76) Inventors: Jochen Franz, Reutlingen (DE); Frank Reichenbach, Wannweil (DE); Dieter Maurer, Reutlingen (DE); Holger Hoefer, Sonnenbuehl (DE); Mark-Alexander Schweiker, Stuttgart (DE)

Correspondence Address: KENYON & KENYON LLP, ONE BROADWAY, NEW YORK, NY, 10004, US

(21) Appl. No.: 11/631,249

(22) PCT Filed: May 11, 2005
(86) PCT No.: PCT/EP05/52142

§ 371 Date: Nov. 16, 2007

(30) Foreign Application Priority Data
Jun. 29, 2004 (DE) 102004031315.6

(51) Int. Cl. G01J 5/02

(52) U.S. Cl. 250/339.01; 250/338.1

(57) ABSTRACT

An infrared sensor having at least one measuring structure, which has, for example, a sensor chip having a measuring structure and a cap chip which is attached to the sensor chip and, together with the sensor chip, defines a sensor space; a screen having an internal screen area and an external screen area surrounding the internal screen area being formed on the top side of the cap chip; the internal screen area which is transparent to the infrared radiation to be detected being formed above the measuring structure, and the external screen area being at least partly non-transparent for the incident infrared radiation. The external screen area may be designed in particular as a reflective coating of metal or a dielectric layer, as reflective structuring formed by trenches having oblique surfaces, or as absorbing structuring.

### BACKGROUND INFORMATION

Microstructured infrared sensors may be used in particular in gas detectors in which an IR radiation emitted by a radiation source, for example, an incandescent bulb operated in the low-current range or an IR LED, is transmitted over an absorption path and subsequently received by the infrared sensor, and the concentration of the gases to be detected in the absorption path is inferred from the absorption of the infrared radiation in specific wavelength ranges. Gas sensors of this type may be used in particular in the automotive industry, for example, for detecting a leak in an AC unit operated using CO₂ or for checking the air quality of the ambient air.

The micromechanical infrared sensor normally has a sensor chip having a measuring structure which is sensitive to infrared radiation and a cap chip covering the sensor chip. A sensor space, sealed to the outside in a vacuum-tight manner, is formed between the sensor chip and the cap chip, a cavity being generally formed on the bottom side of the cap chip for this purpose.

The measuring structure sensitive to infrared radiation usually has a diaphragm under which a cavity is formed, and at least one thermopile structure formed on the diaphragm, having two contacted printed conductors made of different, electrically conductive materials, for example, polycrystalline silicon and a metal. An absorber layer which is heated by absorbing the incident IR radiation is applied to the contact area of the printed conductors. The infrared radiation incident from above reaches a sensor space through the silicon cap chip which is transparent to infrared radiation and the absorber layer whose temperature increase may be read out as the thermal voltage of the thermopile structure.

The infrared sensor is typically enclosed in a housing provided with one or more windows. The size of the window is such that the absorber layer is fully illuminated by the infrared radiation. However, in the tolerance-based situation in which the sensor is installed on the housing base, the window is not able to be accurately matched to the lateral dimension of the absorber layer. The window size is therefore designed in such a way that in general infrared radiation also reaches the bulk material of the silicon outside the absorber layer and the diaphragm, and thus the cold end of the thermopile structure.

Since the sensitivity of the infrared sensor is defined by the temperature difference between the warm contact area under the absorber layer and the cold ends of the printed conductors provided in the bulk material, the infrared radiation incident further out in the lateral direction reduces the sensitivity of the infrared sensor. Furthermore, even a minor error in the positioning of the infrared sensor in the housing, or in the positioning of the cover provided with the window on the housing, results in partial shading of the thermopile structure and the absorber layer, which further reduces sensitivity. The assembly tolerance chain is thus defined by the installation of the infrared sensor in the sensor housing and of the cover provided with the window on the housing.

### SUMMARY OF THE INVENTION

The infrared sensor according to the present invention and the method for manufacturing same have the advantage over the related art that a cost-effective screen design and accurate positioning of the screen relative to the position of the infrared-sensitive measuring structure are possible.

According to the present invention, a screen is formed on the top side of the cap chip. This may be accomplished by a suitable coating; a reflective or absorbing coating may be formed in an external screen area and/or an antireflective coating may be formed in an internal screen area. The reflective coating may be applied as a metal layer, for example; furthermore, the internal and/or external screen area may also have a reflective or antireflective effect depending on the wavelength as a dielectric coating of a defined thickness having a refractive index that is different from that of the sensor chip material; the external screen area functions here as a dielectric mirror and the internal screen area as a dielectric anti-reflective coating. Silicon nitride or silicon dioxide, for example, may be applied in a simple and cost-effective manner as the material having a refractive index different from that of the silicon of the cap chip.

According to another embodiment, reflection, diffusion, or absorption of the infrared radiation in the external screen area may also be achieved by appropriately structuring the surface of the cap chip. No additional material has to be applied in this case. Structuring may be provided, for example, in the form of V-shaped trenches having oblique surfaces formed along the crystal faces in a simple manner via wet etching, for example, using KOH. Absorption of the incident infrared radiation may be adjusted via a suitable roughness, which may be achieved, for example, via wet etching or plasma etching.

In addition, the bottom side of the cap chip may also have a trench-type structuring, which captures the radiation passing through the trenches formed on the top side of the cap chip.

### BRIEF DESCRIPTION OF THE DRAWINGS

FIG. 1 shows a section of the infrared sensor system having an infrared radiation source and an infrared sensor having a screen coating on the cap chip.

FIG. 2 shows the infrared sensor of FIG. 1 according to an embodiment having an external reflective screen area.

FIG. 3 shows an infrared sensor according to an alternative embodiment to that of FIG. 2 having an antireflective central screen area.

FIG. 4 shows an infrared sensor according to an alternative embodiment to that of FIG. 2 having reflective and antireflective screen areas.

FIG. 5 shows a section of an infrared sensor system according to an alternative embodiment to that of FIG. 1 having an infrared radiation source and an infrared sensor having screen areas structured on the cap chip.

FIG. 6 shows an enlarged detail of the cap chip of FIG. 5 according to an embodiment having reflective structuring of the external screen area.

FIG. 7 shows a top view of an infrared sensor of FIG. 5 according to another embodiment having a reflective external screen area.

FIG. 8 shows a section of the infrared sensor of FIG. 7.

FIG. 9 shows a section of an infrared sensor according to an alternative embodiment to that of FIGS. 7, 8 having reflective structuring of the top side and bottom side of the cap chip.

FIG. 10 shows an enlarged detail of the cap chip of the system of FIG. 5 having an absorbing external screen area formed by structuring.

### DETAILED DESCRIPTION

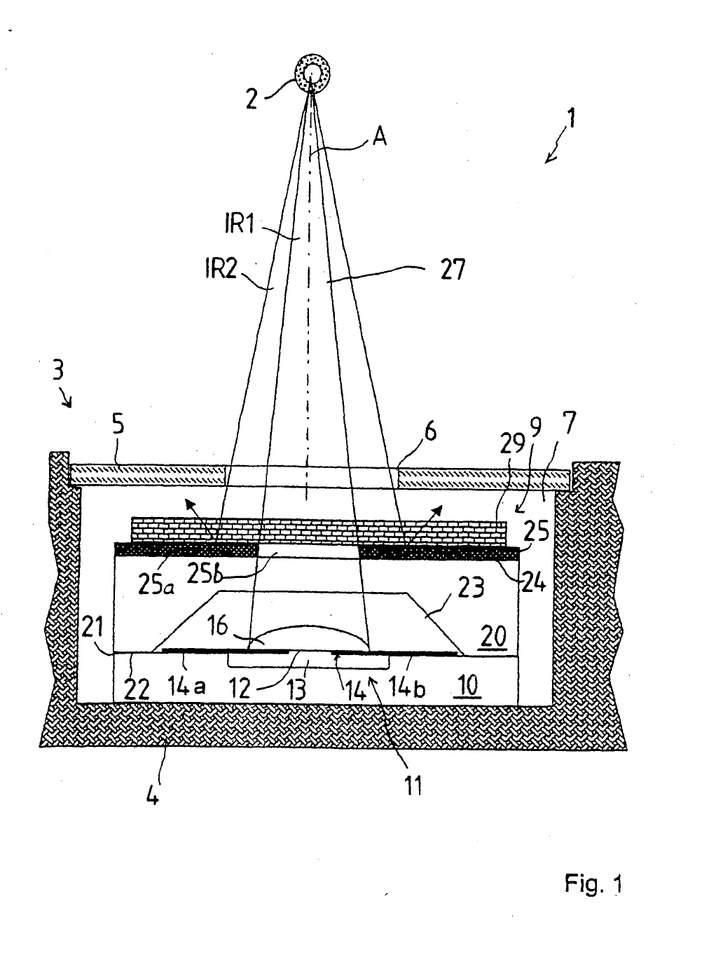

An infrared (IR) sensor system 1 shown in FIG. 1 has an IR radiation source 2, for example, a low-current incandescent lamp, and a sensor module 3 having a housing 4 made of plastic or a molding compound, for example, and a cover 5 attached to housing 4 having a window 6. Provided in internal housing space 7 formed between housing 4 and cover 5 is an infrared sensor 9, for example, glued onto the base of housing 4. Infrared sensor 9 has a sensor chip 10 having a measuring structure 11 which detects IR radiation, measuring structure 11 having a diaphragm 12 formed on the top side of sensor chip 10, a cavity 13 formed underneath diaphragm 12, and at least one thermopile structure 14 formed on diaphragm 12 and having two printed conductors 14a, 14b. Printed conductors 14a and 14b are made of different electrically conductive materials, for example, polycrystalline silicon and a metal, for example, aluminum. They are contacted in a central region of diaphragm 12 and run laterally outward from diaphragm 12. An absorber layer 16 made of a material that absorbs infrared radiation, for example, a metal oxide, is applied to the contact region of thermopile structure 14. Absorber layer 16 is heated when it absorbs infrared radiation, so that thermopile structure 14 experiences a temperature increase in its contact region, which may be read out as a thermovoltage.

A cap chip 20 is attached to sensor chip 10 in vacuum-tight bonding areas 21. Bonding areas 21 may be formed by a low-melting lead glass, for example. A sensor space 23, which accommodates diaphragm 12, thermopile structure 14, and absorber layer 16, is formed as a cavity on the bottom side of cap chip 20. A vacuum is formed in sensor space 23, which is sealed by bonding regions 21 with respect to internal housing space 7.

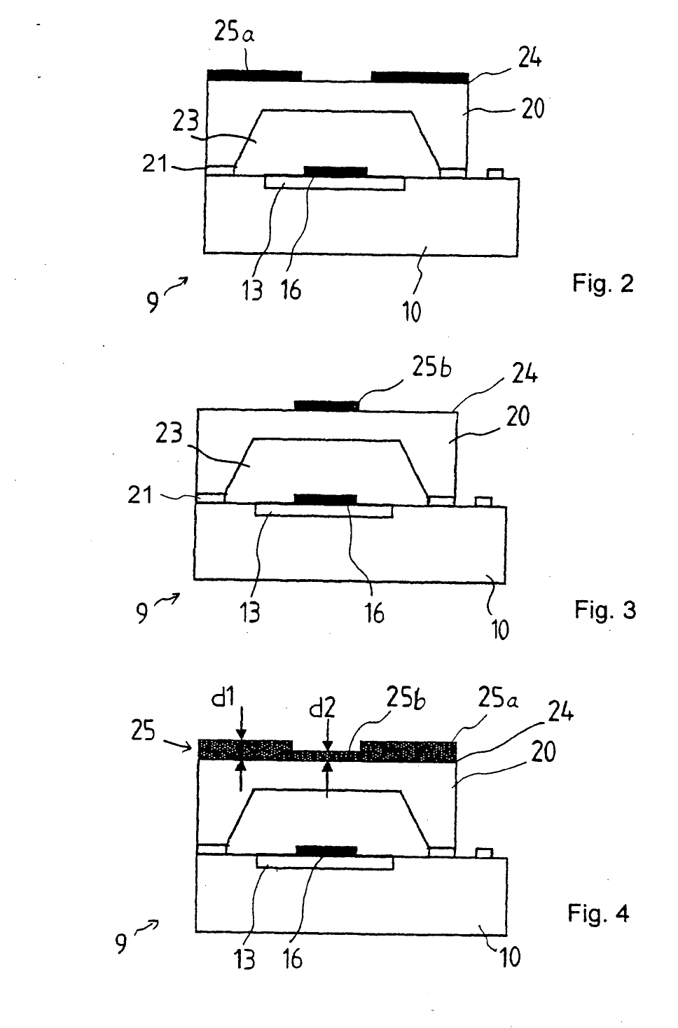

A screen 25 having an external screen area 25a and an internal screen area 25b is formed on a top side 24 of cap chip 20. In the embodiments of FIGS. 1 through 4, screen 25 is designed as a screen coating of top side 24 of cap chip 20, FIG. 2 through 4 showing different alternative embodiments of screen 25.

An infrared radiation filter 29 is attached to screen 25 and thus underneath cover 5. Infrared radiation filter 29 is selectively transparent to infrared radiation of a predefined wavelength range and absorbs other wavelengths. It may be attached using an adhesive layer, for example. As an alternative, IR radiation filter 29 may also be attached, for example, to the bottom side of cover 5 in principle.

Infrared radiation source 2 emits infrared radiation IR to sensor module 3 along an optical axis A, the space between IR radiation source 2 and sensor module 3 functioning as absorption path 27 in which, depending on the particular gas concentration, for example, CO₂ concentration, infrared radiation of the predefined wavelength range is absorbed. Infrared radiation IR1, which is emitted within an internal spatial angle range around optical axis A, passes through window 6, radiation filter 29, internal screen area 25b of screen 25, and silicon cap chip 20, enters sensor space 23, and is absorbed by absorber layer 16. An external infrared radiation IR 2 emitted in an external spatial angle range first passes through window 6 of cover 5 and radiation filter 29, but is not able to pass through external screen area 25a and therefore does not reach cap chip 20.

FIGS. 2 through 4 show alternative embodiments of screen 25 as a coating on top side 24 of cap chip 20. FIG. 2 is identical to FIG. 1 in which external screen area 25a is designed as a reflective coating made of a metal, for example, aluminum, and internal screen area 25b is left exposed. Internal IR radiation IR1 is thus transmitted and external IR radiation IR2 is reflected.

According to FIG. 3, internal screen area 25b is designed as an antireflective screen coating. Such an antireflective coating is designed as the antireflective coating of an optical component and produces destructive interference of the partial waves reflected on the upper boundary surface and lower boundary surface of screen area 25b. For this purpose, thickness d of internal screen coating 25b is to be selected as a function of wavelength λ of the IR radiation and refractive indices n1 of the silicon of cap chip 20 and n2 of internal screen area 25b. If refractive index n1 of cap chip 20 is greater than refractive index n2 of internal screen area 25b, the antireflective effect may be achieved, for example, using a thickness d=(λ/4)/n2. SiO₂ or Si₃N₄ may be selected, for example, as the material of internal screen area 25b.

FIG. 4 shows an embodiment in which, as in FIG. 3, internal screen area 25b is designed as an antireflective surface and external screen area 25a is designed as a reflective surface. External screen area 25a functions as a dielectric mirror having at least one dielectric layer. In the case of a single-layer design, the thickness of external screen area 25a may be d=(λ/2)/n2, i.e., twice the thickness of internal screen area 25b.

Also in FIG. 2, external screen area 25a may be designed as a dielectric mirror, so that FIG. 4 represents a combination of the embodiments of FIG. 2 and FIG. 3.

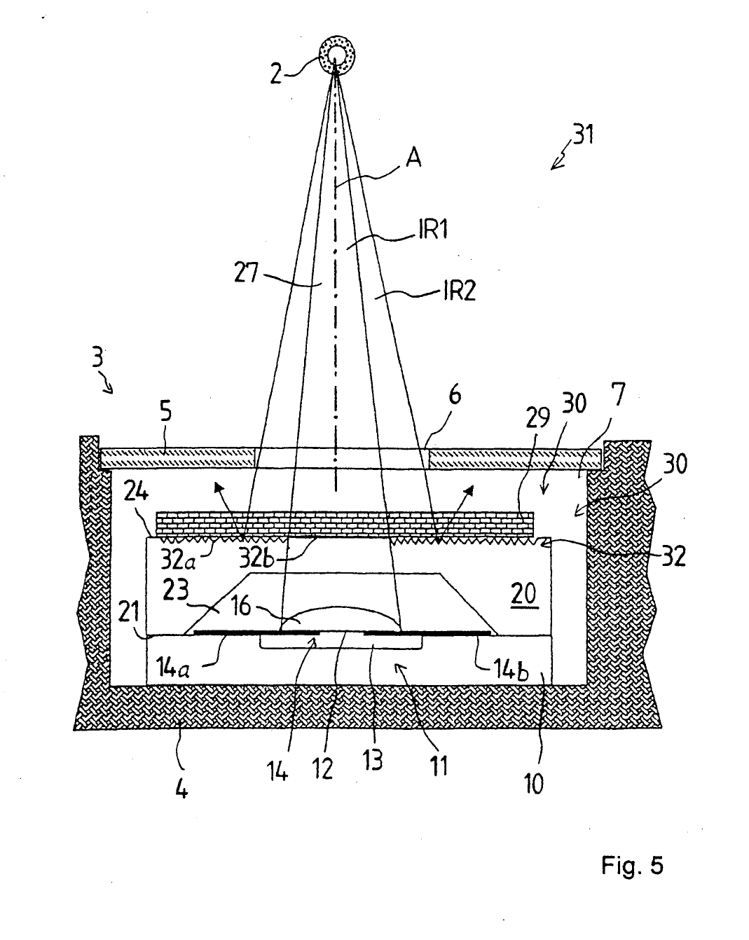

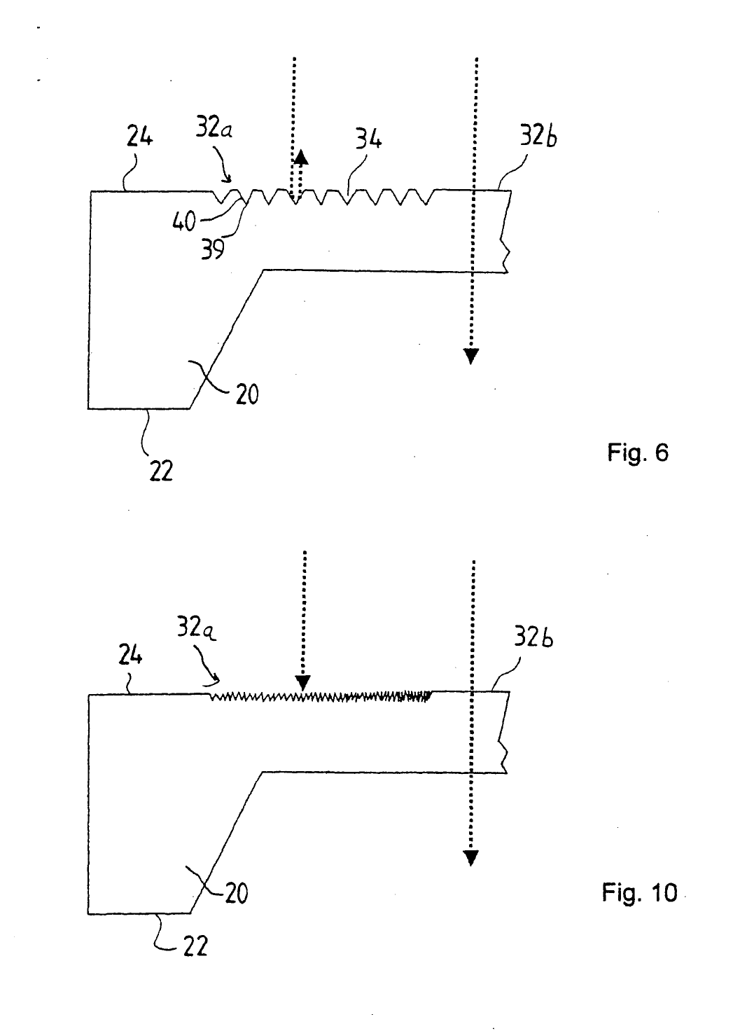

FIG. 5 shows an infrared sensor system 31, which is essentially identical to the design of infrared sensor system 1 of FIG. 1. However, in IR sensor 30, a screen 32 instead of screen coating 25 is formed by structuring on top side 24 of cap chip 20. Screen 32 has in turn an external screen area 32a and an internal screen area 32b, which may have different designs according to the embodiments of FIGS. 6 through 10 described below.

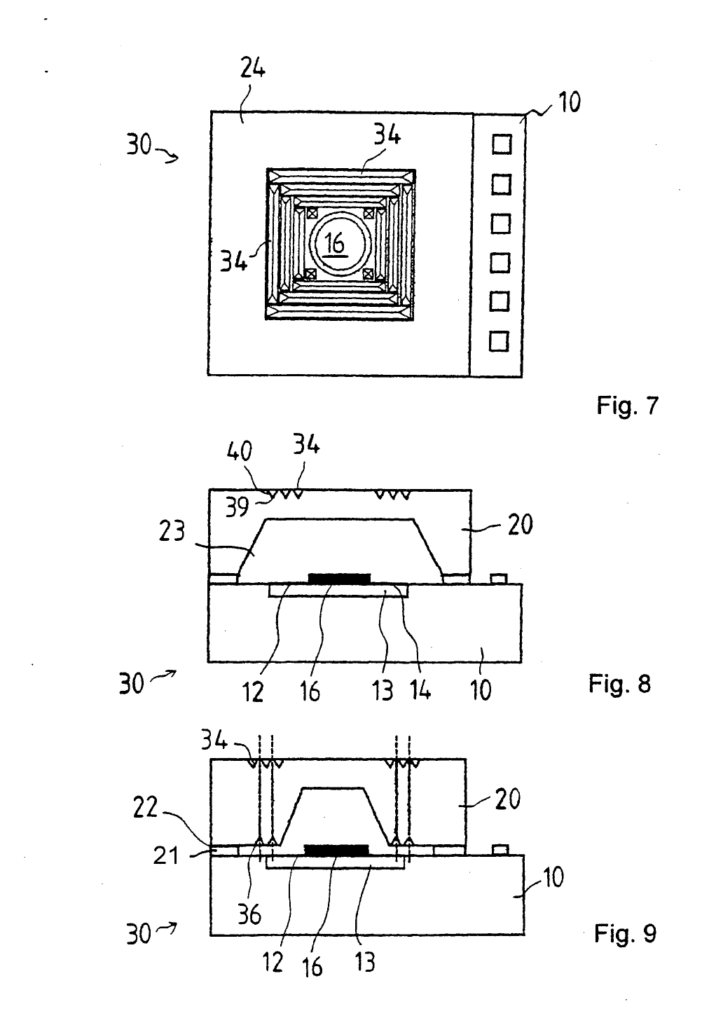

According to the embodiment of FIG. 6, a plurality of small trenches 34 having a V-shaped cross section are formed on top side 24 of cap chip 20 in external screen area 32a. FIGS. 7 and 8 show a similar embodiment having a smaller number of V-shaped trenches 34; three V-shaped trenches 34, for example, may be formed on each side of internal screen area 32b. Trenches 34 run in straight lines and advantageously do not merge at their ends according to the top view of FIG. 7. They may be formed directly by applying a mask layer to top side 24 with subsequent etching, for example, KOH etching. The mask layer leaves trenches 34 exposed. In KOH etching, if the cap wafer has the usual (100) orientation, the etch edges run along the crystal faces, for example, (111) crystal faces, so that the V shape shown in FIGS. 6 and 8 automatically results; the etching procedure is thus identical to the etching of cavity 23 on the bottom side of cap chip 20.

In the embodiment of FIGS. 6 through 9, IR radiation IR1, incident on internal screen area 32b is thus not affected and reaches absorber layer 16 through cap chip 20. IR radiation IR2 incident on external screen area 32a is reflected multiple times by oblique side surfaces 40 of trenches 34. Side surfaces 40 formed by the KOH etching produce an almost full reflection of IR radiation IR2 in which the IR radiation is reflected upward, by multiple reflection on two opposite side surfaces 40, for example, away from top side 24 of cap chip 20.

Since IR radiation IR2 which is not reflected by oblique side surfaces 40 may enter between the individual trenches 34 on top side 24 of cap chip 20, V-shaped trenches 36 which are identical to trenches 34 on top side 24 of cap chip 20, but are offset by one-half of the grid spacing of the latter, i.e., by half the distance between trenches 34, are also formed on bottom side 22 of cap chip 20 in the embodiment of FIG. 9. Edges 39 of the V-shape of upper trenches 34 thus lie exactly between edges 39 of lower trenches 36 and vice-versa, as apparent from the dashed lines of FIG. 9. The IR radiation entering between the upper V-shaped trenches 34 is thus reflected by side surfaces 40 of lower V-shaped trenches 36.

In the embodiment of FIG. 9, unlike the embodiment of FIG. 8, sensor space 23 is smaller in the lateral direction; the flat area of bottom side 22 of cap chip 20 thus extends to below external screen area 32a to make the formation of lower trenches 36 below upper trenches 34 possible.

The embodiment of FIG. 10 shows another option for the design of top side 24 of cap chip 20. External screen area 32a is not reflective, but absorbing in this case. For this purpose, top side 24 of external screen area 32a may be roughened using an appropriate etching procedure. Roughened external screen area 32a may have structures of the same order of magnitude as wavelength λ of the IR radiation, for example; it may be “black silicon,” for example, produced by plasma etching. Internal screen area 32b continues to be transmitting.

IR sensor 9, 30 may be manufactured completely on the wafer level. In this case, a sensor wafer is structured by the method known per se by forming cavities 13, diaphragms 12, thermopile structures 14, and absorber layers 16. Furthermore, a cap wafer is produced in which sensor spaces 23 are formed as cavities by the method known per se, e.g., KOH etching. In the embodiment of FIGS. 1 through 4, screen 25 is subsequently applied to top side 24 by coating as a metallized layer and/or dielectric, optically transparent layer of a certain thickness having reflective or antireflective properties, for example, SiO₂ or Si₃N₄. Since this coating takes place on the wafer level, the additional cost per cap chip 20 is low. In the embodiment of FIGS. 5 through 10, instead of coating, top side 24 of cap chip 20 is structured, for example, by KOH etching. When forming the V-shaped trenches of FIGS. 6 through 9, an appropriate masking technique is used; in the embodiment of FIG. 9, in addition to cavities 23, V-shaped trenches 36 are also formed on bottom side 22 of the cap wafer. In FIG. 10, top side 24 is roughened by plasma etching, for example.

In all embodiments, the sensor wafer and cap wafer may be placed on top of one another and attached in the vacuum-tight bonding areas 21. The wafer stack thus formed may be subsequently diced, producing individual IR sensors 9, 30. IR radiation filter 29 may be applied before or after dicing.

Thus manufactured IR sensors 9, 30 may be accommodated in housing 4 having cover 5.

1-17. (canceled)

18. An infrared sensor comprising:
at least one sensor chip having a measuring structure;
a cap chip attached to the sensor chip and, together with the sensor chip, defining a sensor space; and
a screen having an internal screen area and an external screen area surrounding the internal screen area being situated on a top side of the cap chip, the internal screen area which is transparent to infrared radiation to be detected being situated above the measuring structure, the external screen area being at least partly non-transparent to incident infrared radiation.

19. The infrared sensor according to claim 18, wherein the measuring structure has a diaphragm, a cavity formed underneath the diaphragm, at least one thermopile structure formed on the diaphragm and having two printed conductors contacting one another and an absorber layer covering the thermopile structure.

20. The infrared sensor according to claim 18, wherein at least one of the internal screen area and the external screen area has a coating applied to the top side of the cap chip.

21. The infrared sensor according to claim 20, wherein the external screen area has a reflective coating, which is reflective for the incident infrared radiation of at least one predefined wavelength.

22. The infrared sensor according to claim 21, wherein the reflective coating is one of a metal layer and a dielectric coating reflecting specific wavelengths having a refractive index different from that of the cap chip.

23. The infrared sensor according to claim 22, wherein the reflective coating has a smaller refractive index than the cap chip and has a thickness according to
d=(2m+1)λ/2n2, where
d is the thickness of the reflective coating,
λ is a wavelength to be detected,
m is a natural integer,
n2 is the refractive index of the reflective coating.

24. The infrared sensor according to claim 20, wherein the internal screen area has an antireflective dielectric coating having a refractive index different from that of a material of the cap chip.

25. The infrared sensor according to claim 24, wherein the antireflective coating has a smaller refractive index than the cap chip and has a thickness according to
d=(2m+1)λ/4n2, where
d is the thickness of the reflective coating,
λ is a wavelength to be detected,
m is a natural integer,
n2 is the refractive index of the reflective coating.

26. The infrared sensor according to claim 23, wherein the dielectric coating has one of silicon nitride and silicon oxide.

27. The infrared sensor according to claim 18, wherein the external screen area of the screen has at least one of a reflective and absorbing structuring on the top side of the cap chip.

28. The infrared sensor according to claim 27, wherein the external screen area has trenches having obliquely-by-receding lateral surfaces, including a V-shaped cross section.

29. The infrared sensor according to claim 28, wherein lower trenches, each situated in a lateral direction between trenches running on the top side of the cap chip, are formed on a bottom side of the cap chip.

30. The infrared sensor according to claim 27, wherein the external screen area has a roughened surface for absorbing the incident infrared radiation.

31. The infrared sensor according to claim 18, further comprising an infrared radiation filter attached to the screen for wavelength-specific transmission of incident infrared radiation.

32. A sensor module comprising:
an infrared sensor including:
at least one sensor chip having a measuring structure,
a cap chip attached to the sensor chip and, together with the sensor chip, defining a sensor space, and
a screen having an internal screen area and an external screen area surrounding the internal screen area being situated on a top side of the cap chip, the internal screen area which is transparent to infrared radiation to be detected being situated above the measuring structure, the external screen area being at least partly non-transparent to incident infrared radiation;
a housing accommodating the infrared sensor; and
a cover attached to the housing, the cover having a window, the window being situated above the internal screen area and being transparent for a larger spatial angle of the infrared radiation than the internal screen area.

33. A method for manufacturing an infrared sensor, comprising:
structuring a sensor wafer having a plurality of measuring structures;
structuring a cap wafer having a plurality of cavities formed on a bottom side and screens formed on a top side above the cavities;
attaching the cap wafer to the sensor wafer in vacuum-tight bonding areas, in each case forming a vacuum in sensor spaces between the sensor wafer and the cap wafer; and
dicing the infrared sensor from a wafer stack including the cap wafer and the sensor wafer.

34. The method according to claim 33, wherein the screens include at least one of a coating and a structuring on the top side of the cap wafer.
